(19) United States
(12) Patent Application Publication
(10) Pub. No.: US 2026/0042011 A1
(43) Pub. Date: Feb. 12, 2026

(54) MACHINE LEARNING FOR VIDEO GAME HELP SESSIONS

(71) Applicant: Microsoft Technology Licensing, LLC, Redmond, WA (US)

(72) Inventors: Monica Ann ADJEMIAN, Los Angeles, CA (US); Andrew H. FARRIER, Redmond, WA (US); Jennifer R. GURIEL, Kirkland, WA (US); Gershom PAYZER, Redmond, WA (US); Daniel Gilbert KENNETT, Bellevue, WA (US)

(73) Assignee: Microsoft Technology Licensing, LLC, Redmond, WA (US)

(21) Appl. No.: 18/798,063

(22) Filed: Aug. 8, 2024

(51) Int. Cl. A63F 13/5375; A63F 13/67; A63F 13/87; G06N 20/00

(52) U.S. Cl. CPC A63F 13/5375; A63F 13/67; G06N 20/00; A63F 13/87

(57) ABSTRACT

The disclosed concepts relate to training a machine learning model to provide help sessions during a video game. For instance, prior video game data from help sessions provided by human users can be filtered to obtain training data. Then, a machine learning model can be trained using approaches such as imitation learning, reinforcement learning, and/or tuning of a generative model to perform help sessions. Then, the trained machine learning model can be employed at inference time to provide help sessions to video game players.

### CROSS-REFERENCE TO RELATED APPLICATIONS

This application is related to, and incorporates by reference in their entirety, the following: U.S. Pat. No. ______ (Attorney Docket No. 057846-US01), U.S. Pat. No. ______ (Attorney Docket No. 502018-US01), U.S. Pat. No. ______ (Attorney Docket No. 502019-US01), U.S. Pat. No. ______ (Attorney Docket No. 502021-US01), and U.S. Pat. No. ______ (Attorney Docket No. 502022-US01).

### BACKGROUND

Video game players often encounter difficult gaming situations, such as difficult enemies, difficult items to find, difficult levels to complete, etc. In some cases, video game players will seek the assistance of other video game players, e.g., by posting on online forums to get suggestions from other members of the video gaming community to overcome difficult parts of a given game. In other cases, video game players consult online videos of other players demonstrating how to overcome difficult gaming situations. However, these techniques are rather rudimentary.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to video game help sessions. One example entails a computer-implemented method or technique that can include accessing prior gameplay data for a particular video game from prior help sessions by one or more video game helpers. The method or technique can also include evaluating the prior gameplay data to identify selected prior help sessions related to a particular condition in the particular video game. The method or technique can also include extracting training data from the prior gameplay data for the selected prior help sessions. The method or technique can also include based on the training data extracted from the selected prior help sessions, training a machine learning model to assist with playing the particular video game. The method or technique can also include outputting the trained machine learning model.

Another example entails a computer-implemented method or technique that can include initiating a current help session for a current video game player during a current gaming session of a particular video game. The method or technique can also include during the current help session, obtaining output of the particular video game. The method or technique can also include providing the output to a trained machine learning model, wherein the trained machine learning model has been adapted to assist with playing the particular video game based at least on selected prior help sessions by one or more video game helpers. The method or technique can also include receiving generated inputs from the trained machine learning model. The method or technique can also include providing the generated inputs to the particular video game. The method or technique can also include ending the current help session and returning to the current gaming session.

Another example entails a system that includes processing resources and storage resources. The storage resources can store computer-readable instructions which, when executed by the processing resources, cause the processing resources to initiate a current help session for a current video game player during a current gaming session of a particular video game. The computer-readable instructions can also cause the system to during the current help session, obtain output of the particular video game and provide the output to a trained machine learning model, wherein the trained machine learning model has been adapted to assist with playing the particular video game based at least on selected prior help sessions by one or more video game helpers. The computer-readable instructions can also cause the system to during the current help session, receive generated inputs from the trained machine learning model and provide the generated inputs to the particular video game. The computer-readable instructions can also cause the system to end the current help session and return to the current gaming session.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example machine learning model, consistent with some implementations of the present concepts.

FIG. 2 illustrates an example computer vision model, consistent with some implementations of the present concepts.

FIG. 3 illustrates an example generative language model, consistent with some implementations of the present concepts.

FIG. 4 illustrates example help sessions for a first video game, consistent with some implementations of the present concepts.

FIG. 5 illustrates example help sessions for a second video game, consistent with some implementations of the present concepts.

FIGS. 6A, 6B, 6C, 6D, 6E, 6F, 6G, and 6H illustrate an example help session for the first video game, consistent with some implementations of the present concepts.

FIG. 7 illustrates an example workflow for training and employing a machine learning model to provide a help session, consistent with some implementations of the present concepts.

FIG. 8 illustrates an example system in which the present concepts can be employed.

FIG. 9 illustrates a method for training a machine learning model to play a video game, consistent with some implementations of the present concepts.

FIG. 10 illustrates a method for providing a video game help session using a trained machine learning model, consistent with some implementations of the present concepts.

### DETAILED DESCRIPTION

### Overview

As noted above, video game players sometimes seek help from other video game players to overcome in-game difficulties, often by consulting online forums or videos. However, while this type of help is widely available, it takes a great deal of effort for users to seek out the assistance they need to accomplish their goal. Furthermore, these techniques may take the video game players out of the gaming experience while they search for external help content.

The disclosed implementations aim to address these issues by providing automated help sessions for video game players using a trained machine learning model. For instance, the disclosed implementations can evaluate prior gameplay data from help sessions performed by human video game players, and then extract training data from the prior game sessions. Then, the training data can be employed to train a machine learning model to assist a current video game player during a current gaming session.

### Machine Learning Overview

There are various types of machine learning frameworks that can be trained to perform a given task, such as detecting triggering conditions and ending conditions for help sessions. Support vector machines, decision trees, random forests, and neural networks are just a few examples of suitable machine learning frameworks that have been used in a wide variety of other applications, such as image processing and natural language processing.

A support vector machine is a model that can be employed for classification or regression purposes. A support vector machine maps data items to a feature space, where hyperplanes are employed to separate the data into different regions. Each region can correspond to a different classification. Support vector machines can be trained using supervised learning to distinguish between data items having labels representing different classifications.

A decision tree is a tree-based model that represents decision rules using nodes connected by edges. Decision trees can be employed for classification or regression and can be trained using supervised learning techniques. Multiple decision trees can be employed in a random forest, which significantly improve the accuracy of the resulting model relative to a single decision tree. In a random forest, the individual outputs of the decision trees are collectively employed to determine a final output of the random forest. For instance, in regression problems, the output of each individual decision tree can be averaged to obtain a final result. For classification problems, a majority vote technique can be employed, where the classification selected by the random forest is the classification selected by the most decision trees.

A neural network is another type of machine learning model that can be employed for classification or regression tasks. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values of a neural network. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, decoding, alignment, prediction, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned, e.g., individualized tuning to one or more particular users. Note that two trained models can share the same model structure and yet have different values for the internal parameters, e.g., if the two models are trained on different training data or if there are underlying stochastic processes in the training process.

### Terminology

The term “prior gameplay data,” as used herein, refers to various types of data associated with gameplay of a video game. Prior gameplay data can include gameplay sequences, e.g., of inputs to a video game and/or outputs of the video game during prior gaming sessions. Prior gameplay data can also include communication logs relating to the game, such as in-game chat or voice sessions or external data such as forum posts regarding a particular game. Prior gameplay data can also include platform data collected by a video gaming platform, such as an online game playing service utilized by multiple video games or an operating system that runs on a gaming console. Prior gameplay data can also include instrumented game data that can be stored by the video game itself during execution for subsequent evaluation. Note that prior gameplay data can include very recent gameplay data obtained in real-time from live video game play.

A “help session” is an experience that occurs to assist a video game player with a particular portion of a video game. For instance, a help session can include a tutorial, e.g., text, chat, or video-based. A help session can also include transferring control of a video game session to another game player that temporarily takes over control of a video game until the help session is completed. The other game player can be a human being or a trained machine learning model. A “video game helper” is a human or machine learning model that plays a video game during a help session.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as ChatGPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a multi-modal generative model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include CLIP models, certain GPT variants such as GPT-4o, Gemini, etc.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Neural Network

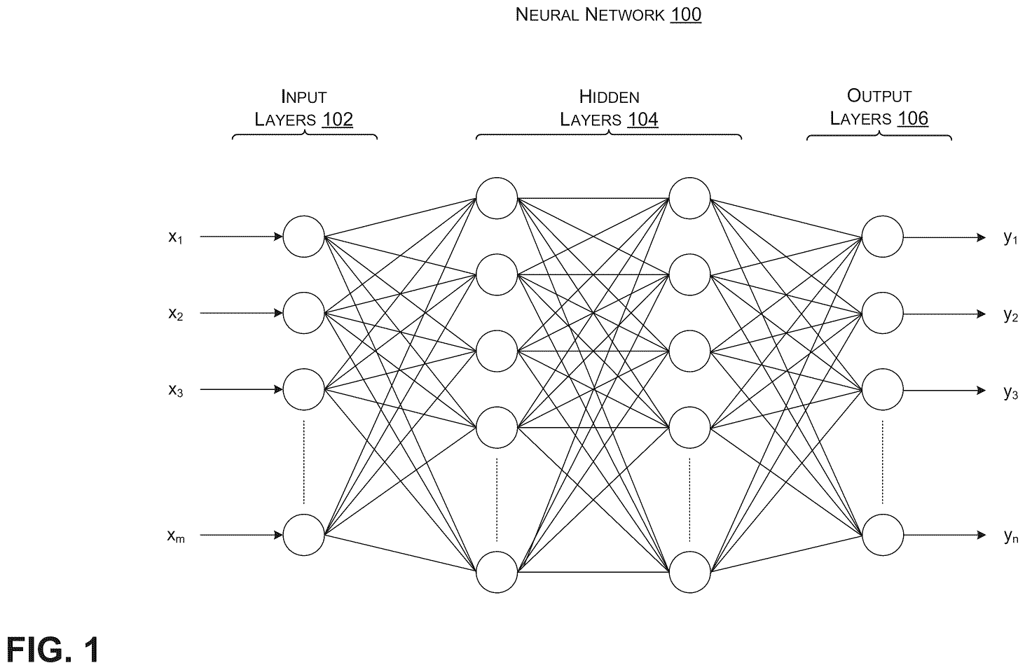

FIG. 1 shows a deep neural network 100 with input layers 102, hidden layers 104, and output layers 106. The input layers can receive features x₁ through xₘ. For instance, the features can relate to prior gameplay data for one or more video games, and can include features relating to gameplay sequences by one or more players, features relating to communication logs from players discussing the video game, features relating to platform data collected by a gaming platform that executes the video game, and/or game data (e.g., telemetry) collected by the video game itself when executing.

The input layers can feed into the hidden layers 104. The hidden layers feed into the output layers 106. The output layers can output values y₁ through yₙ. For instance, the output values can characterize any aspect of video game play at any point during the video game. In some cases, the output values are calculated using a regression approach, and in other cases using a classification approach.

In a regression approach, the output values can characterize any aspect of a video game using a numerical value. For instance, one output layer could generate a value for an analog input on a video game controller, e.g., a joystick or trigger that provides a range of values as input to a video game. In a classification approach, the output values can include probability distributions over two or more classes. For instance, one output layer could output a binary probability distribution of pressing a first button on a video game controller, another output layer could output a binary probability distribution of pressing another button on the video game controller, etc.

Neural network 100 is shown with a general architecture that can be modified depending on the task being performed by the neural network. For instance, neural networks can be implemented with convolutional layers to implement a computer vision model or as a transformer encoder/decoder architecture to implement a generative language or multi-modal generative. Neural networks can also have recurrent layers such as long short-term memory networks, gated recurrent units, etc.

### Example Computer Vision Model

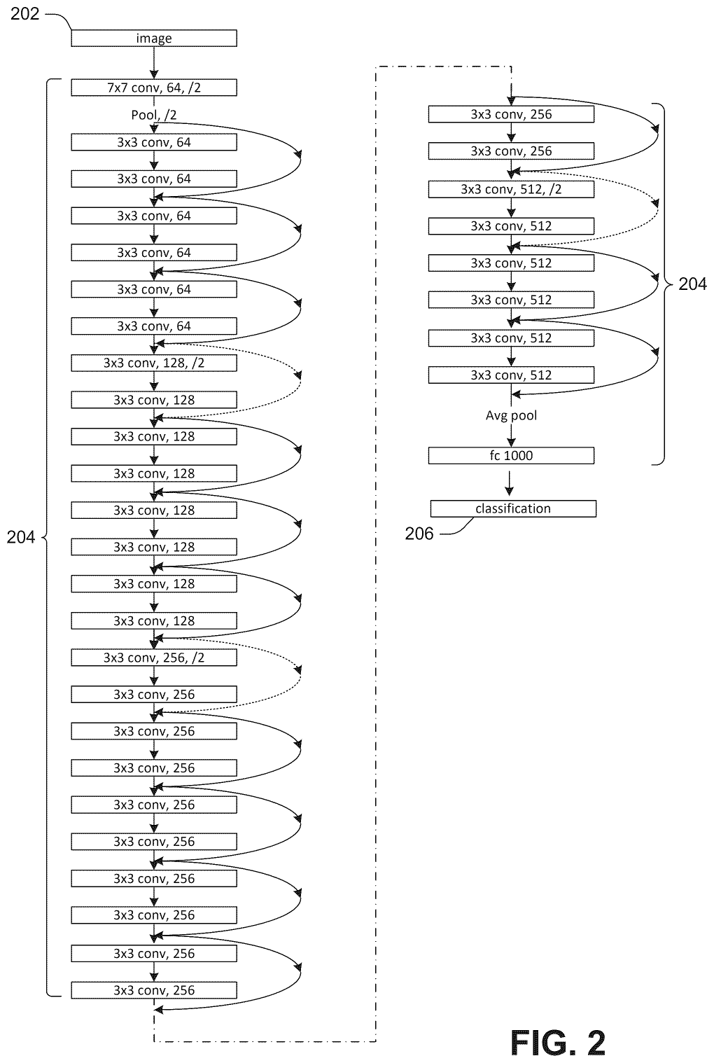

While FIG. 1 illustrates a general architecture of a neural network, FIG. 2 illustrates a particular example of a neural network model for computer vision. For instance, FIG. 2 shows an image 202 being classified by a computer vision model 204 to determine an image classification 206. For instance, the image can include part or all of a video frame output by a video game, and computer vision model 204 can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters. If the feature map size is halved by a given convolutional layer (as shown by “/2” in FIG. 2), then the number of filters can be doubled to preserve the time complexity across layers.

After the image has been processed using a series of convolutional layers, the image is processed in a global average pooling layer. The output of the pooling layer is processed with a 1000-way fully-connected layer with softmax. The fully-connected layer can be used to determine a classification, e.g., an object category of an object in image 202.

The respective layers within computer vision model 204 can have shortcut connections which perform identity operations:

$$y = F ( x , \{ {W}_{i} \} ) + x \qquad ( 1 )$$

where x and y are the input and output vectors of the layers involved and F (x, {Wᵢ}) represents the residual mapping to be learned. In some connections the dimensions increase across layers (shown as dotted lines in FIG. 2). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 204 can be pretrained on a large dataset of images, such as ImageNet. Such a general-purpose image database can provide a vast number of training examples that allow the model to learn weights that allow generalization across a range of object categories. Said another way, computer vision model 204 can be pretrained in this fashion.

After pretraining, computer vision model 204 can be tuned on another, smaller dataset for categories of interest. For instance, tuning datasets can be provided for specific video games, genres of video games, etc. As one example, some genres of video games tend to have health status bars or important, powerful enemies (“bosses”), and computer vision model 204 could be tuned to detect health status and/or boss fight scenarios using training data from multiple games from a particular genre. For instance, the training data could include video frames with associated labels, e.g., either manually-labeled health bars or boss fights or implicit labels obtained from user chat logs, forum discussions, etc.

### Example Decoder-Based Generative Language Model

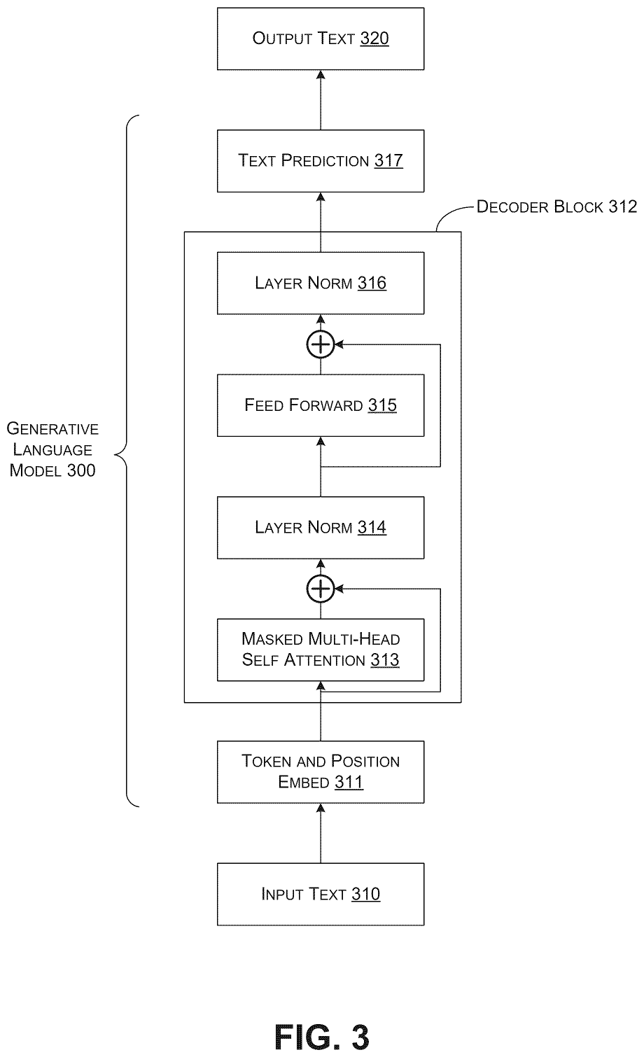

While FIG. 1 illustrates a general architecture of a neural network, FIG. 3 illustrates a particular example of a neural network model for language generation. Specifically, FIG. 3 illustrates an exemplary generative language model 300 (e.g., a transformer-based decoder) that can be employed using the disclosed implementations. Generative language model 300 is an example of a machine learning model that can be used to perform one or more natural language processing tasks that involve generating text, as discussed more below. For the purposes of this document, the term “natural language” means language that is normally used by human beings for writing or conversation.

Generative language model 300 can receive input text 310, e.g., a prompt from a user or a prompt generated automatically by machine learning using the disclosed techniques. For instance, the input text can include words, sentences, phrases, or other representations of language. The input text can be broken into tokens and mapped to token and position embeddings 311 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 311 are processed in one or more decoder blocks 312. Each decoder block implements masked multi-head self-attention 313, which is a mechanism relating different positions of tokens within the input text to compute the similarities between those tokens. Each token embedding is represented as a weighted sum of other tokens in the input text. Attention is only applied for already-decoded values, and future values are masked. Layer normalization 314 normalizes features to mean values of 0 and variance to 1, resulting in smooth gradients. Feed forward layer 315 transforms these features into a representation suitable for the next iteration of decoding, after which another layer normalization 316 is applied. Multiple instances of decoder blocks can operate sequentially on input text, with each subsequent decoder block operating on the output of a preceding decoder block. After the final decoding block, text prediction layer 317 can predict the next word in the sequence, which is output as output text 320 in response to the input text 310 and also fed back into the language model. The output text can be a newly-generated response to the prompt provided as input text to the generative language model.

Generative language model 300 can be trained using techniques such as next-token prediction or masked language modeling on a large, diverse corpus of documents. For instance, the text prediction layer 317 can predict the next token in a given document, and parameters of the decoder block 312 and/or text prediction layer can be adjusted when the predicted token is incorrect. In some cases, a generative language model can be pretrained on a large corpus of documents (Radford, et al., “Improving language understanding by generative pre-training,” 2018). Then, a pretrained generative language model can be tuned using a reinforcement learning technique such as reinforcement learning from human feedback (“RLHF”). In other examples, a generative language model could be tuned using training data from a specific video game or games from a particular genre to determine when various help session criteria are met or to characterize in-game conditions relative to help session criteria. For instance, as described more below, the tuning data can be obtained from prior help sessions, and the generative language model can be tuned to produce video game inputs in response to video game outputs.

### Example Gameplay Data for Adventure Game Help Sessions

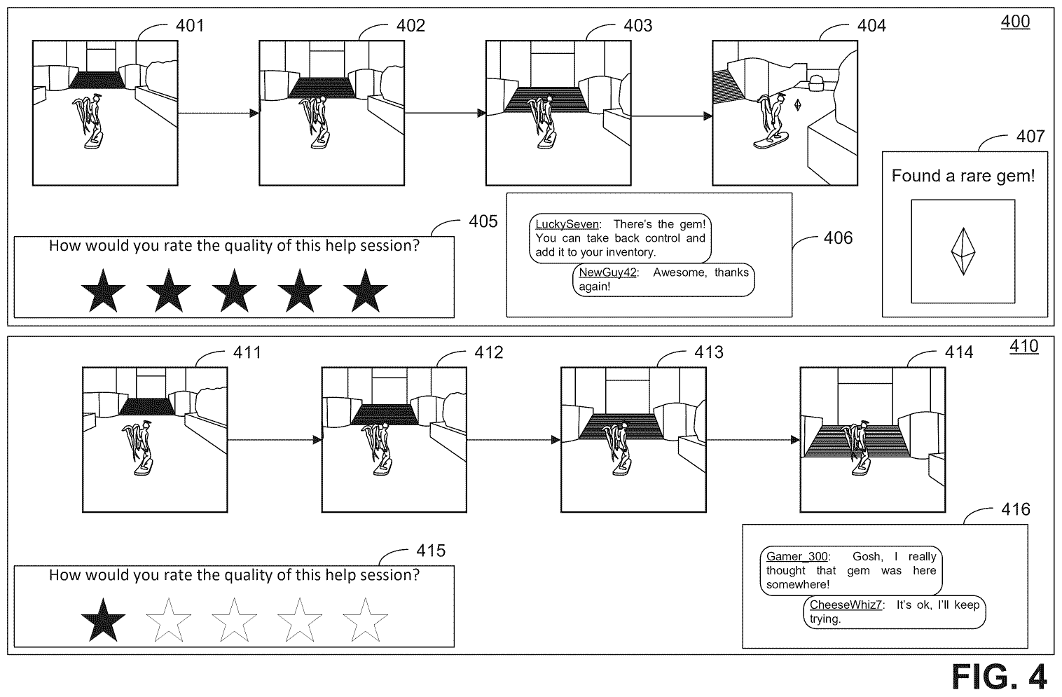

Gameplay data associated with help sessions can be useful for training a machine learning model to play a video game during an automated help session. FIG. 4 shows some examples of gameplay data that can be associated with help sessions by human video game players for an adventure video game. As described more below, the adventure video game involves controlling a character riding a hoverboard, and one of the in-game goals involves finding a rare gem.

FIG. 4 shows gameplay data 400, associated with a first help session by a video game player named LuckySeven assisting another video game player named NewGuy42, and gameplay data 410, associated with a second help session by a video game player named Gamer_300 assisting another video game player named CheeseWhiz7. As described more below, LuckySeven is more successful at assisting NewGuy42 than Gamer_300 is at assisting CheeseWhiz7.

In gameplay data 400, the character moves forward through frame 401, frame 402, frame 403, and frame 404, looking for a gem while being controlled by LuckySeven. At frame 404, the gem comes into view, and control is transferred back to NewGuy42. NewGuy42 gives a help session rating 405 of five stars to LuckySeven, and a chat log 406 indicates NewGuy42 was pleased by the help session. In addition, the help session resulted in an achievement 407.

In gameplay data 410, the character moves forward through frame 411, frame 412, frame 413, and frame 414, looking for the gem while being controlled by Gamer_300. At frame 414, Gamer_300 moves past the turn without finding the gem, and control is transferred back to CheeseWhiz7. CheeseWhiz7 gives a help session rating 415 of one star to Gamer_300, and a chat log 416 indicates CheeseWhiz7 will keep trying without help from Gamer_300. Note that gameplay data 410 does not include an achievement.

### Example Gameplay Data for Racing Game Help Sessions

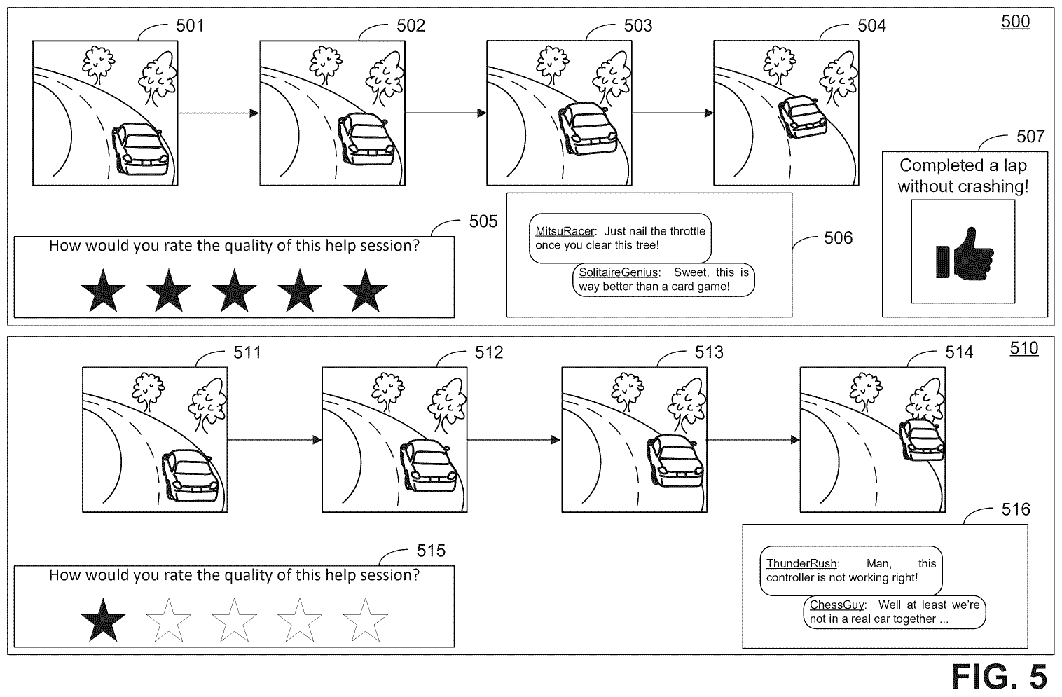

FIG. 5 shows some examples of gameplay data that can be associated with help sessions by human video game players for a racing video game. As described more below, the racing video game involves controlling a car driving along a course, where incorrectly navigating a turn can result in crashing into a tree.

FIG. 5 shows gameplay data 500, associated with a first help session by a video game player named MitsuRacer assisting another video game player named SolitaireGenius, and gameplay data 510, associated with a second help session by a video game player named ThunderRush assisting another video game player named ChessGuy. As described more below, MitsuRacer is more successful at assisting SolitaireGenius than ThunderRush is at assisting ChessGuy.

In gameplay data 500, the car moves forward through frame 501, frame 502, frame 503, and frame 504, speeding past the tree while being controlled by MitsuRacer. At frame 504, the lap has been completed without crashing, and control is transferred back to SolitaireGenius. SolitaireGenius gives a help session rating 505 of five stars to MitsuRacer, and a chat log 506 indicates SolitaireGenius was pleased by the help session. In addition, the help session resulted in an achievement 507.

In gameplay data 510, the character moves forward through frame 511, frame 512, frame 513, and frame 514, racing along the course while being controlled by ThunderRush. At frame 514, ThunderRush crashes into the tree, and control is transferred back to ChessGuy. ChessGuy gives a help session rating 515 of one star to ThunderRush, and a chat log 516 indicates ChessGuy made a sarcastic response to ThunderRush. Note that gameplay data 510 does not include an achievement.

### Example Adventure Game Help Session

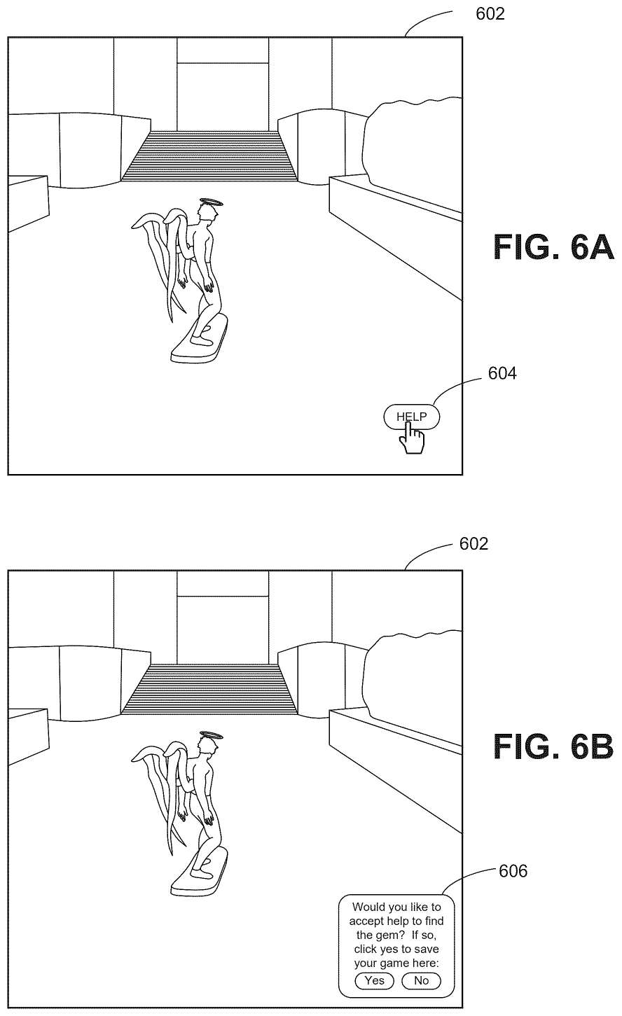

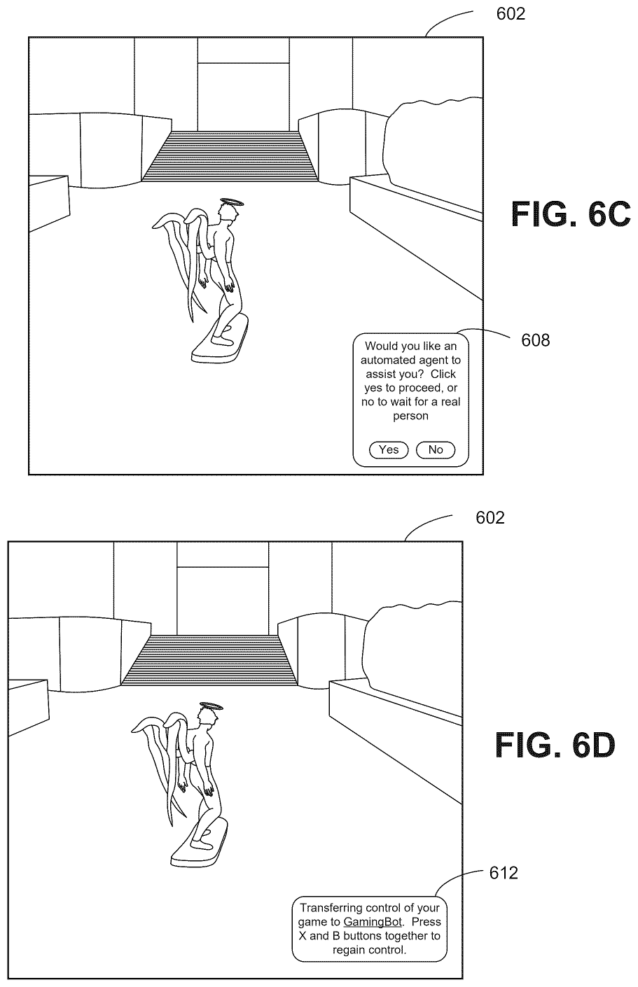

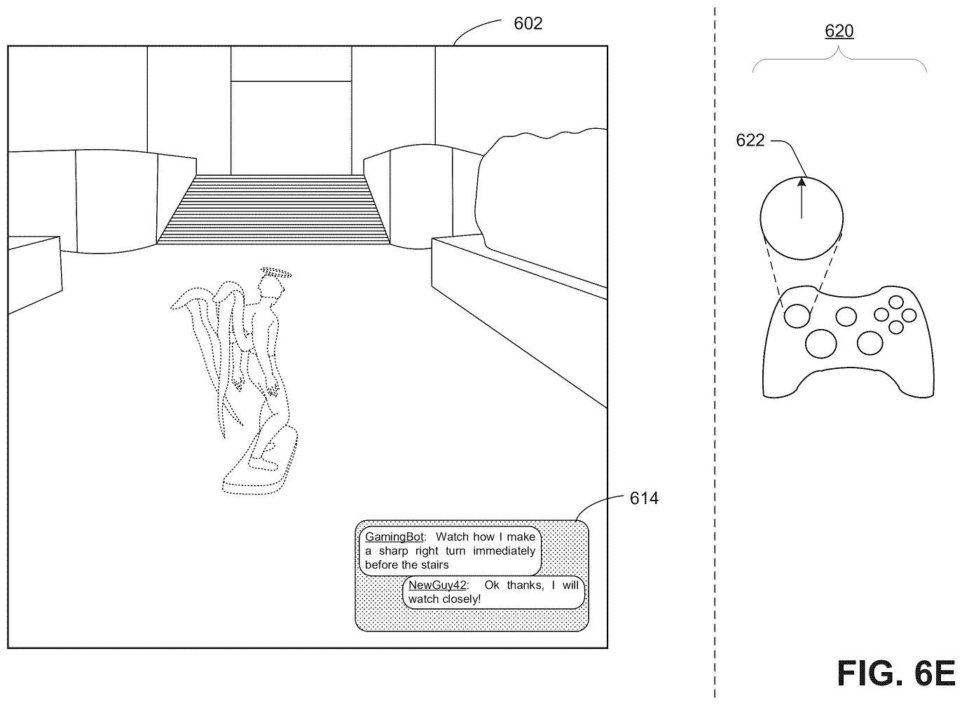

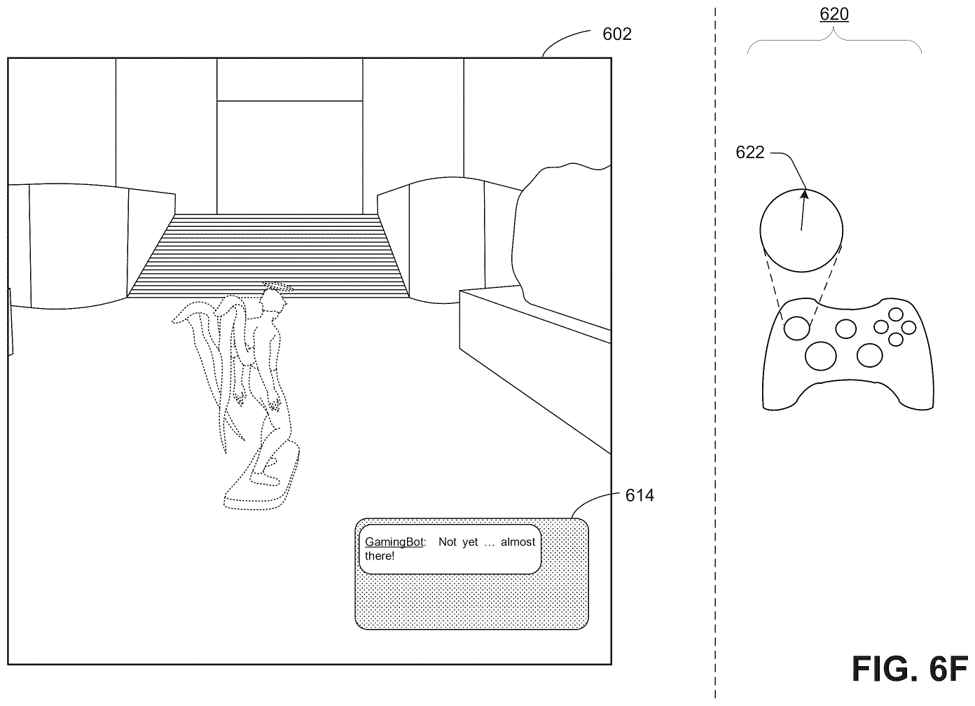

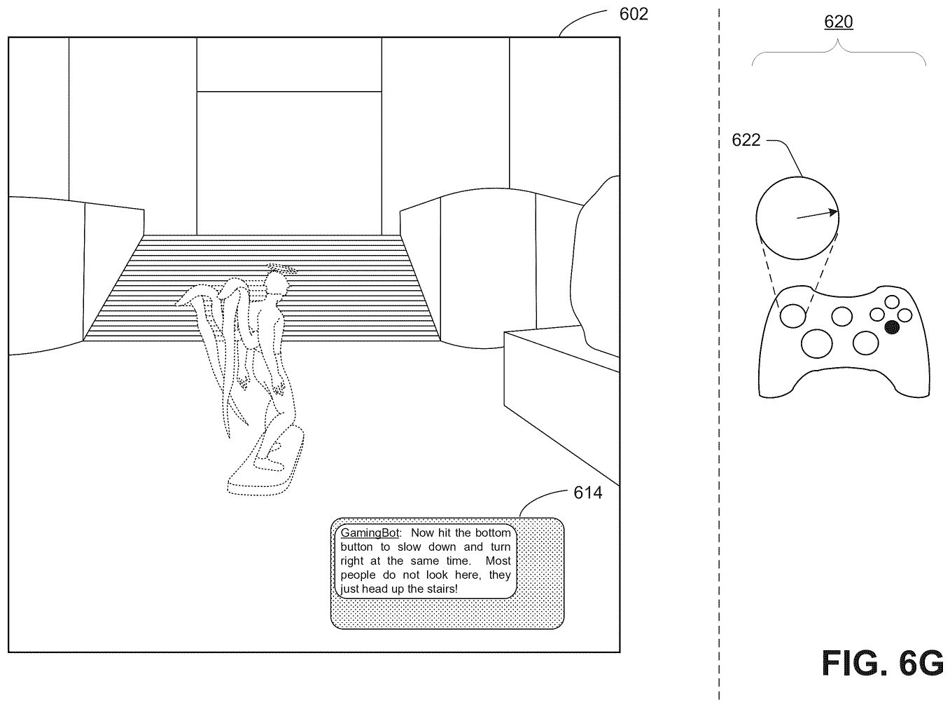

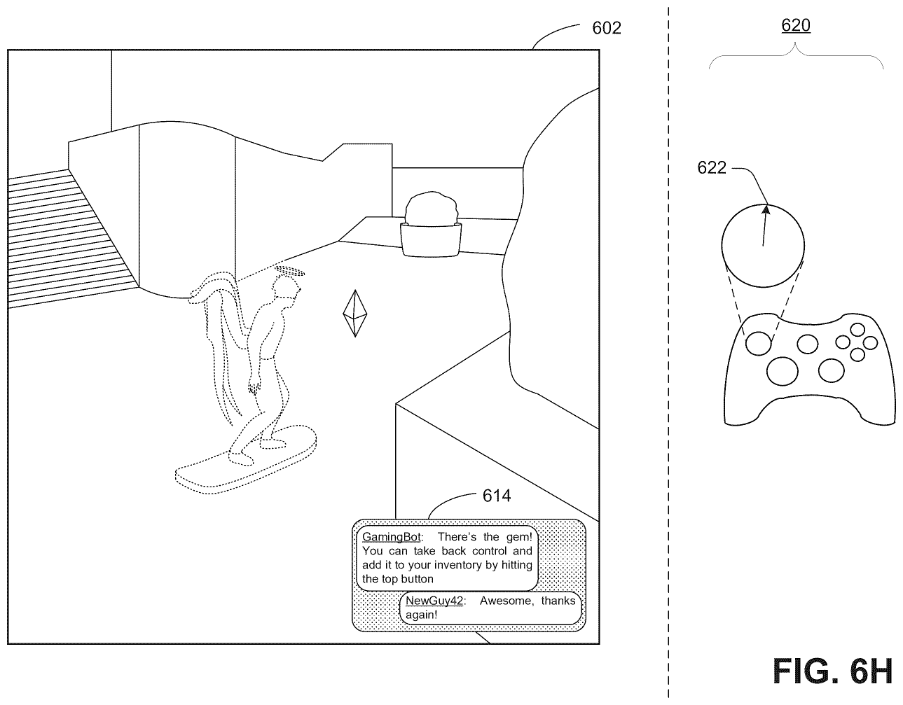

FIGS. 6A through 6H collectively illustrate an example help session experience relating to the adventure video game introduced previously. FIG. 6A shows a help session triggering condition being detected in a current video game session. Note that a video frame 602 is visually similar to frame 401 and frame 411, as discussed above with respect to FIG. 4. One way to detect that a help session should be offered during a current video game session is to compare the output of the current video game session to prior outputs associated with prior help sessions, e.g., by comparing embeddings representing video and/or audio output. When one or more embeddings for the current video game session are sufficiently similar to the one or more embeddings associated with the prior help sessions, the help session can be triggered.

When the help session is triggered, a help icon 604 can be presented on the screen, as shown in FIG. 6A. When the current video game player selects the help icon, a help save 606 icon is displayed, as shown in FIG. 6B. When the current video game player selects the help save icon, the current game state is saved and the help session can proceed as follows. For instance, the current game state can represent the location of the character, items accrued in their inventory, health status, etc.

Next, a helper notification icon 608 is displayed, as shown in FIG. 6C. Here, the helper data indicates that the current video game player can select yes to have an automated agent provide a help session, or not to wait for a real person to provide the help session. When the current video game player clicks “yes,” then a help session transfer notification 612 is shown indicating control is being transferred to an automated helper called “GamingBot,” as shown in FIG. 6D.

As shown in FIG. 6E, the help session begins at frame 602 where the current video gaming session was saved. A chat dialog 614 is displayed along with a video game controller representation 620. In the chat dialog, the automated helper explains how to move the character to achieve the in-game goal of finding the rare gem. The video game controller representation shows the inputs provided by the helper agent to their own video game controller during the help session, and includes a joystick representation 622, which employs an arrow to show the direction in which the helper's joystick is pointed to maneuver the character. Also note that the character can be modified graphically to convey that the character is being controlled by a trained machine learning model adapted to play the video game. For instance, the color, size, transparency, or shape of the character can be modified, and/or a textual indication can be provided.

Next, in FIG. 6F, the character continues along the path. The helper agent explains that the character is almost there, and the joystick representation 622 remains pointed nearly straight ahead. Next, in FIG. 6G, the joystick representation 622 moves to the right, and the bottom button on controller representation 620 is now black to indicate this button has been pressed. The chat dialog updates with an explanation from the helper agent that the bottom button slows the character down, and that now is the time to make the sharp right turn. The chat dialog also explains that this is a point in the video game where many players do not look to the right and most continue to go up the stairs without finding the gem.

Next, in FIG. 6H, a gem is visible. At this time, control can return to the current video game player, e.g., the presence of the gem in the current video game frame can be used to end the help session. In some implementations, the game state from the helper session can be loaded into the current video game session, with the character at the new location. In other implementations, the game state can revert to the previous game state that was saved when the help session was initiated, and the current video game player can attempt to find the gem themselves using the information that they learned during the help session. Note that the help session can be automatically ended at this point according to a help session ending condition, e.g., indicating that the gem was found and/or based on a comparison of an embedding representing the video frame shown in FIG. 6G to an average embedding of successful help sessions that resulted in finding the gem.

### Example Workflow

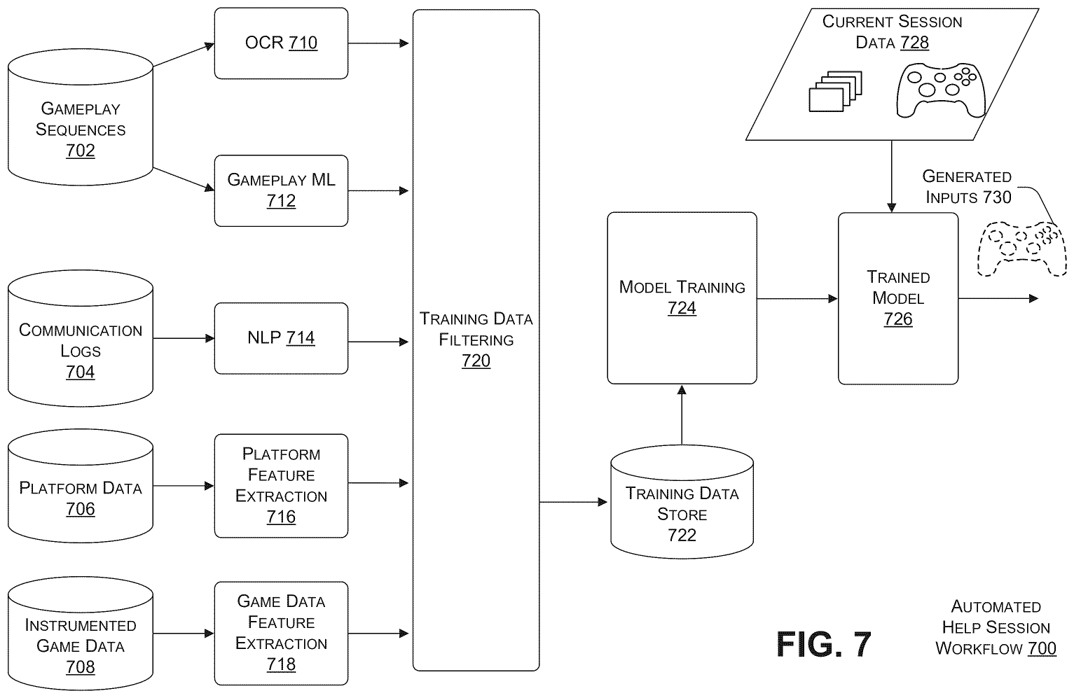

FIG. 7 shows an example automated help session workflow 700. Various sources of prior gameplay data can be obtained from one or more help sessions for a particular video game. For instance, the prior gameplay data can include gameplay sequences 702, communication logs 704, platform data 706, and instrumented game data 708.

Gameplay sequences 702 can include various sequences of video game outputs (video, audio, and/or haptic) and/or inputs obtained from one or more prior video game help sessions where human video game players assisted other human video game players. Optical character recognition 710 can be performed on video frames in the gameplay sequences to obtain on-screen text features. In addition, gameplay machine learning 712 can be performed on the video frames, audio output, and/or video game input to obtain ML-detected features. For instance, the ML-detected features can include object identifiers or embeddings obtained using computer vision model 204, described previously. Note that in some cases the video frames are provided at full resolution for optical character recognition, but smaller images may be provided for computer vision or multi-modal models. For instance, lower-resolution images may be provided as input to these models, and/or a given video frame may be divided into smaller patches prior to being input to the computer vision model (e.g., for a vision transformer).

Communication logs 704 can include chat or voice logs obtained during prior gaming sessions, e.g., communications between a helper and another video game player during a help session for a particular video game. The communication logs can also include other types of communications, such as online forum discussions relating to a particular video game. The communication logs can be processed using natural language processing 714 to obtain natural language processing features. For example, the natural language processing features can include sentiment relating to specific game scenarios.

Platform data 706 can include data collected by a video gaming platform on which one or more video games can execute. The platform data can include in-game achievements, saves, restarts, disengagement data, etc. The platform data 706 can be input to platform feature extraction 716 to extract platform features.

Instrumented game data 708 can include telemetry data collected by one or more video games. For example, games can track data such as levels completed, enemies defeated, etc. The instrumented game data can be input to game data feature extraction 718 to extract game data features.

The various features extracted from the prior gameplay data can be input to training data filtering 720. The filtering can involve identifying help sessions that relate to similar in-game conditions according to one or more filtering criteria. For instance, as discussed more below, machine learning and/or rules-based approaches can be employed to identify help sessions that relate to a common in-game goal (e.g., finding a particular item such as a gem, completing a particular part of a racecourse, etc.). The filtering can also identify filtering out negative training examples, e.g., help sessions that were not successful or highly-rated by the video game player receiving assistance. After filtering, the remaining prior gameplay data can be used to populate training data store 722.

Next, model training 724 is performed using training data store 722 to obtain a trained model 726. For instance, as discussed more below, imitation or reinforcement learning can be employed to train a machine learning model to perform a help session, e.g., by assisting a current video game player with playing the video game. In other cases, a pretrained model, such as a generative language model or generative multi-modal model, can be tuned using the training data in the training data store.

Once the trained model 726 has been trained, the trained model can be employed to assist with video game play during one or more help sessions. For instance, current session data 728 can be received, where the current session data can include output video or audio frames, controller inputs, etc. In other cases, the current session data can also include communications, platform data, or game data associated with the current gaming session. The trained model output generated inputs 730, which can be provided to a video game during the help session.

### Example System

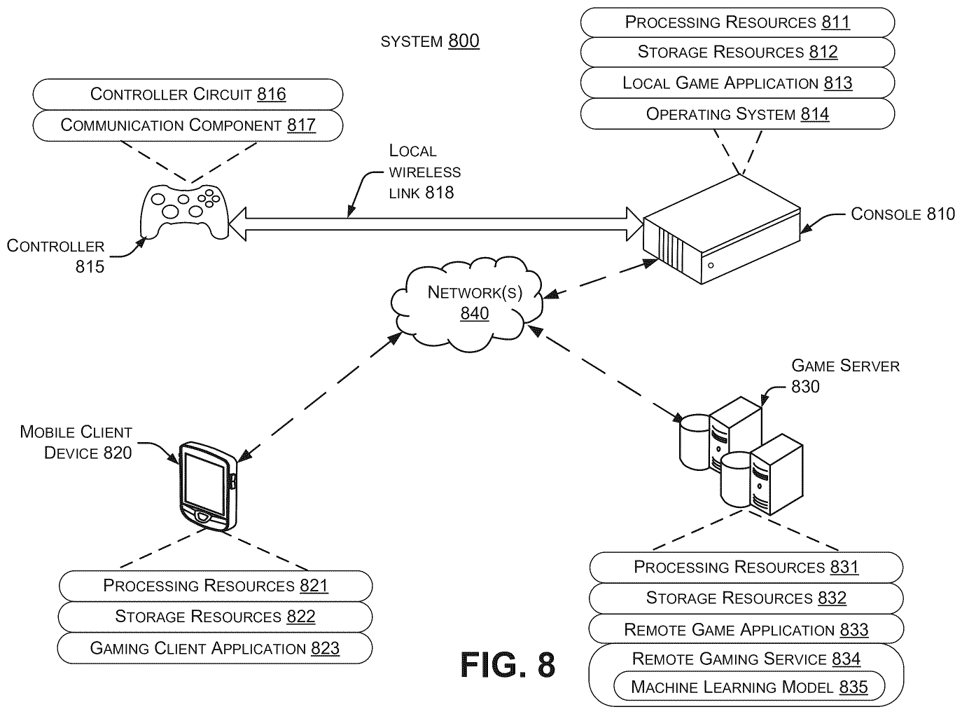

The present concepts can be implemented in various technical environments and on various devices. FIG. 8 shows an example system 800 in which the present concepts can be employed, as discussed more below. As shown in FIG. 8, system 800 includes a console client device 810, a mobile client device 820, and a game server 830. Console client device 810, mobile client device 820, and server 830 are connected over one or more networks 840.

Console client device 810 can have processing resources 811 and storage resources 812, mobile client device 820 can have processing resources 821 and storage resources 822, and game server 830 can have processing resources 831 and storage resources 832. The devices of system 800 may also have various modules that function using the processing and storage resources to perform the techniques discussed herein, as discussed more below.

Console client device 810 can include a local game application 813 and an operating system 814. The local game application can execute using functionality provided by the operating system. The operating system can obtain control inputs from controller 815, which can include a controller circuit 816 and a communication component 817. The controller circuit can digitize inputs received by various controller mechanisms such as buttons or analog input mechanisms such as joysticks. The communication component can communicate the digitized inputs to the console client device over the local wireless link 818. The control interface module on the console can obtain the digitized inputs and provide them to the local application. The operating system can collect platform data during execution, and the game can collect instrumented game data during execution.

Mobile client device 820 can have a gaming client application 823. The gaming client application can send inputs from a touchscreen on the mobile client device and/or peripheral game controller to the server 830, and can also receive game outputs, such as video, chat, and/or audio streams, from the server(s) and output them via a display, loudspeaker, headset, etc.

Server 830 can include a remote game application 833, which can correspond to a streaming version of a video game. The server 830 can also have a remote gaming service 834, which can execute the remote game application and provide various support services, such as maintaining user accounts, tracking achievements, etc. The remote game platform can also train a machine learning model 835 using prior gameplay data from help sessions for games offered by the platform and then execute the trained machine learning model to provide an automated help session.

When a help session is initiated for a game executed on the console client device 810, a cloud instance of a streaming version of the video game can be instantiated by the remote gaming service. Then, the saved game state from the console can be used as an initial state for the help session, running on the cloud instance. For instance, the trained machine learning model, acting as an automated helper, can play a streaming version of the game using mobile client device 820. When completed, the game state of the streaming session can be sent to the console, and the current user can resume gameplay from that state.

Note that other implementations can involve running an automated help session on another local console of the helper. Similarly, in some cases the current game session is a streaming cloud session and the help session can be implemented on a local console of the helper. In other cases, both the current gaming session and the help session are streaming cloud instances of the video game. In further implementations, the help session is implemented by a machine learning model executed on the console, the game server, and/or the mobile device. For instance, the game server 830 can distribute the trained machine learning model 835 to one or more client devices for local execution thereon.

### Example Training Method

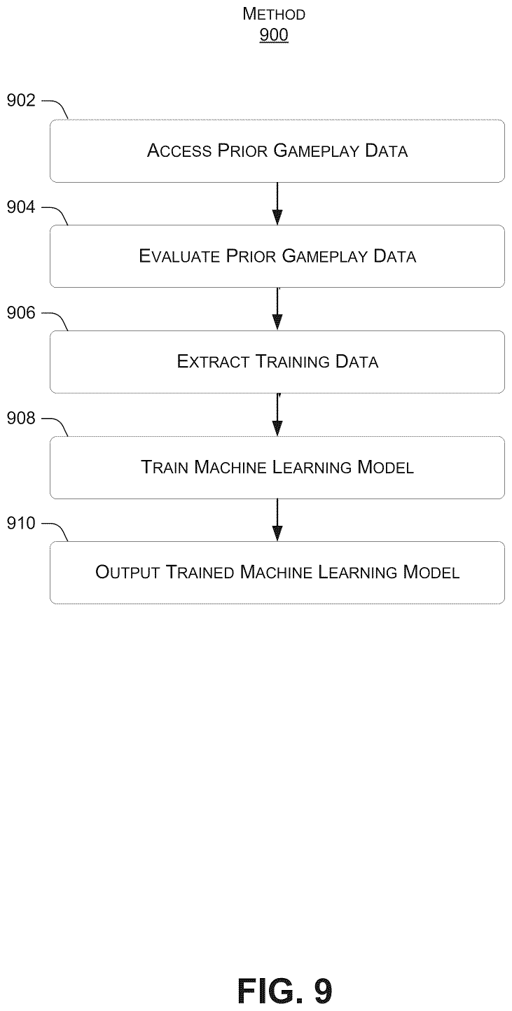

FIG. 9 illustrates an example computer-implemented method 900 that can be used to train a machine learning model to help a current video game player with a video game. As discussed elsewhere herein, method 900 can be implemented on many different types of devices, e.g., by one or more cloud servers, by a client device such as a laptop, tablet, or smartphone, or by combinations of one or more servers, client devices, etc.

Method 900 begins at block 902, where prior gameplay data is accessed. For instance, the prior gameplay data can include prior gameplay sequences as well as communication logs, platform data, and/or instrumented game data associated with the prior gameplay sequences.

Method 900 continues at block 904, where the prior gameplay data is evaluated to select prior help sessions relating to a particular condition in a particular video game. For instance, the prior video game data can be evaluated using machine learning and/or rules-based approaches to identify prior help sessions that relate to a common goal (e.g., finding a particular item such as a gem, completing a particular part of a racecourse, etc.). Block 904 can also involve filtering out negative training examples, e.g., prior, help sessions that were not successful or highly-rated by the video game player receiving assistance.

Method 900 continues at block 906, where training data is extracted from the selected prior help sessions identified at block 904. For instance, the training data can include sequences of video game output from the selected prior help sessions, as well as sequences of video game inputs that helpers input to the particular video game during the selected prior help sessions.

Method 900 continues at block 908, where a machine learning model is trained based on the training data extracted from the selected prior help sessions. For instance, imitation or reinforcement learning can be employed to train a machine learning model to assist with video game play, e.g., during a help session. In other cases, a pretrained model, such as a generative language model or generative multi-modal model, can be tuned using the training data in the training data store.

Method 900 continues at block 910, where the trained machine learning model is output. For instance, the trained machine learning model can be sent to another device (e.g., a client device such as a gaming console, personal computer, mobile phone, tablet, or augmented or virtual-reality headset) for remote execution, or can be output to storage for subsequent local execution.

### Example Inference Method

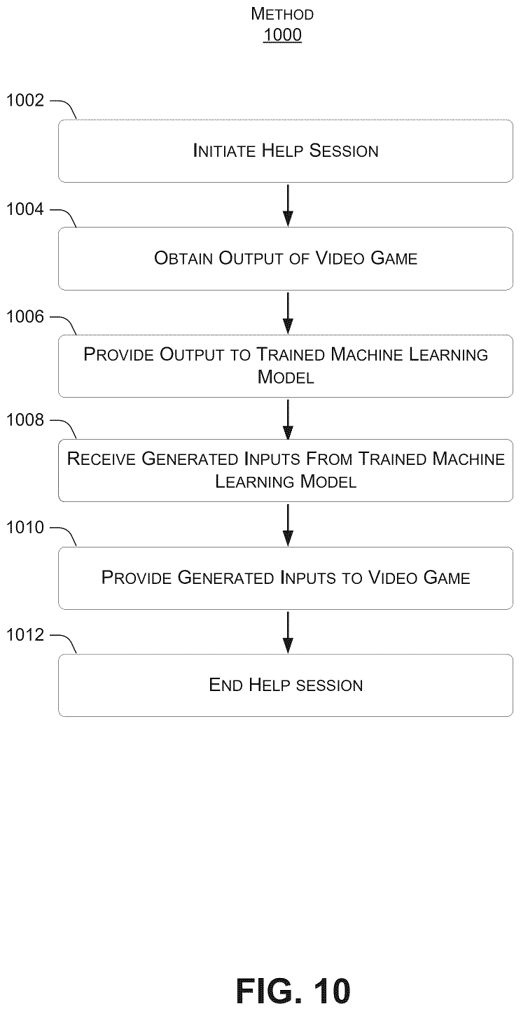

FIG. 10 illustrates an example computer-implemented method 1000 that can be used to employ a trained machine learning model to provide a help session for a current video game player. As discussed elsewhere herein, method 1000 can be implemented on many different types of devices, e.g., by one or more cloud servers, by a client device such as a laptop, tablet, or smartphone, or by combinations of one or more servers, client devices, etc.

Method 1000 begins at block 1002, where a current help session is initiated. For instance, a current video game player may explicitly request a help session, or a help session may be offered to the current video game player by detecting that current output of the video game matches output from one or more selected help sessions. For instance, in some implementations, a help session can be triggered by comparing one or more embeddings representing a current video frame to an average embedding computed over starting frames of the selected prior help sessions. If the embeddings are sufficiently similar (e.g., within a threshold distance in a vector space), then a help session can automatically be initiated at block 1002.

Method 1000 continues at block 1004, where output of a video game is obtained. For instance, the output can include video, audio, and/or haptic output of the video game. The output can be obtained from a local instance of the video game or over a network from a remote instance.

Method 1000 continues at block 1006, where the output is provided to a trained machine learning model that has been trained to assist with playing the video game. For instance, the trained machine learning model may have one or more layers configured to map video, audio, and/or haptic outputs into corresponding embeddings that are processed internally within the trained machine learning model. In other cases, a computer vision model can extract a natural language description of video output and provide that description as input to another model, e.g., a generative language model.

Method 1000 continues at block 1008, where generated inputs are received from the trained machine learning model. For instance, the trained machine learning model can output values for analog video game controller input mechanisms (e.g., from a range of values for a joystick or trigger), Boolean values representing whether binary input mechanisms (e.g., buttons) are depressed, etc. In other cases, the trained machine learning model can provide keyboard, mouse, and/or touch screen inputs. In further cases, the trained machine learning model can output decisions in natural language or computer code format (e.g., JSON), such as “purchase the sword for 100 rubies” or “trade the horse for the motorcycle,” and one or more rules can be employed to map these decisions to video game inputs.

Method 1000 continues at block 1010, where the generated inputs are provided to the video game. For instance, the generated inputs can be provided to a local instance of the video game and/or sent over a network to a remote instance of the video game.

Method 1000 continues at block 1012, where the help session is ended. The help session can end when the current video game player requests that the help session ends, the helper decides to end the help session, and/or a help session ending condition is detected. For instance, a help session ending condition can occur when a given in-game goal is reached, and can be detected by comparing current video game output to video game output from the selected prior help sessions (e.g., an average embedding of video frames).

### Further Implementations

The following section provides some additional details and specific examples of how the concepts described above can be implemented. There are a wide range of techniques that can be employed to identify training data for training a machine learning model to provide help sessions. There are also a wide range of machine learning models and training techniques that can be employed.

First, consider how training data can be filtered and identified from a large database of prior gameplay data. In some cases, the prior gameplay data can include many help sessions involving a particular video game. However, different help sessions may correspond to different in-game conditions. Consider the adventure video game introduced above. There may be portions of the game where the character starts without wings or a hoverboard, navigates different types of environments (e.g., a city, a desert, a mountain range) to find or earn the wings and hoverboard before the game segment where the gem can be found. There may also be subsequent game segments after finding the gem, e.g., the character may trade the gem for a spaceship, fly into outer space, and then find another rare item such as a warp drive for the spaceship. There may be help sessions associated with any of these in-game conditions, e.g., it may be relatively easy to earn your wings or find the hoverboard, but there may still be some help sessions associated with these goals. In a similar manner, there may be many help sessions for a racing video game with difficult sections, where some of the help sessions are associated with relatively easy sections of the racecourse.

The disclosed techniques can analyze prior help session data to identify groups of help sessions that are associated with a particular in-game condition. For example, note that frames 401 and 411 above in FIG. 4 are visually similar, e.g., the character is in a very similar environment, has a hoverboard and wings, etc. In some implementations, a computer vision model can compute embeddings on video output associated with help sessions and then the help sessions can be clustered (e.g., using K-means or another clustering algorithm) to identify clusters of help sessions. Generally speaking, the more help sessions in a given cluster, the more difficulty video game players may have with that part of the video game. In other words, help sessions may tend to be more concentrated around difficult parts of a video game, and clustering techniques can be employed to identify which help sessions are associated with the same in-game conditions.

Another way to identify help sessions associated with a particular in-game condition could involve employing a generative model. For instance, prior gameplay data associated with a particular video game can be input to a generative multi-modal model. The generative multi-modal model could identify which help sessions are associated with which in-game conditions and/or goals. For instance, a natural language description of the video game could be provided to the generative multi-modal model, and then the generative multi-modal model could evaluate video output from various helper sessions and generate natural language or computer code (e.g., JSON) descriptions of what is occurring in the video output.

Using the techniques above, training data for specific in-game conditions can be identified. Some implementations can use helper ratings provided by video game players that have been helped to further filter the training data, e.g., by excluding help sessions with low ratings from the help data. In other cases, implicit signals such as whether a helpee accepted the game state at the end of a help session can be employed to select which help sessions are employed for training.

Once the training data is obtained, a machine learning model can be trained to conduct help sessions using various approaches. In an imitation learning approach, such as behavioral cloning, a neural network or decision tree could learn a mapping between video game states (e.g., from video, audio, and/or haptic output) to corresponding inputs provided by the helpers in the selected help sessions. Said another way, the machine learning model can be trained to maximize the likelihood of one or more training trajectories in the training data, where the trajectories correspond to states and inputs in the selected help sessions.

In a reinforcement learning approach, a model such as a neural network can be trained using a Q_learning, actor-critic, or policy gradient approach. Generally, the goal of reinforcement learning is for the model to learn a policy that determines which actions the model takes in a given state. For instance, a reward function can be defined that encourages the model to achieve a specific goal, such as improving user engagement (e.g., video game players keep playing the game instead of quitting), successfully accomplishing in-game goals, having video game players accept the results of a help session, etc. In some cases, the model can learn online, e.g., by playing the game and updating its own parameters based on the reward function. Training can balance exploration vs. exploitation, where exploration involves trying actions that are suboptimal according to the current policy to learn whether those actions might ultimately lead to higher rewards, whereas exploitation involves following the current policy, e.g., choosing the action that the current policy predicts will maximize the reward.

In still further implementations, a machine learning model is pretrained using imitation learning and then subsequently refined or tuned using reinforcement learning. This approach can ensure that the model initially provides good performance by imitating successful help sessions. Then, the model can start to explore the action space on its own and potentially learn new approaches for successfully playing a given video game. In some cases, a multi-modal model can be employed to evaluate video game output for determining a reward value of a given session. For instance, if a multi-modal model indicates that the model achieved a particular goal, e.g., finding a rare gem, then the reward function can reflect the determination by the multi-modal model. Conversely, if the multi-modal model indicates that the model failed to achieve the goal, the reward function can reflect this determination. In some cases, a model can be trained or tuned using reinforcement learning with rewards determined using a multi-modal model prior to being employed to actually conduct help sessions.

In still further implementations, generative machine learning models can be employed to conduct help sessions. For instance, some multi-modal generative models are trained using examples of video game outputs, and can perform artificial reasoning to make decisions about how to play a given game. For instance, consider a role-playing game where the goal is to buy, sell, or barter to acquire items with other players or non-player characters. A multi-modal generative model could be provided current game output indicating how much money a player has, what items the player has in their inventory, etc. Then, the multi-modal generative model could determine what trades, purchases, or sales the player should attempt to transact. In some cases, the multi-modal model could even generate natural language to conduct an in-game negotiation.

In other cases, the multi-modal generative model can generate text outputs describing how to use a video game controller, e.g., “press the x button now” or “move the joystick upward and to the left,” and these text descriptions can be mapped to corresponding controller inputs and provided to an instance of an executing video game. In other cases, a multi-modal model can be provided a library of skills to choose from and invoke individual skills. For instance, there may be a preprogrammed attack skill, a preprogrammed explore skill, and a preprogrammed retreat skill for a fighting game. The skills themselves may be hard-coded or provided by other machine learning models, and the multi-modal generative model can decide when to invoke the respective skills in response to game outputs. In addition, as described above in FIGS. 6E through 6H, a generative language model can also generate language output describing its own game inputs during a help session, e.g., while a graphical user interface depicting those inputs is displayed to the current video game player being helped.

In some cases, a given generative multi-modal model may not be trained sufficiently to perform well at a given game scenario. There are several ways to address this issue. In some implementations, prior gameplay data from selected help sessions can be input to the generative multi-modal model as examples. This is a form of in-context learning that does not necessarily involve updating the internal parameters of the model. Rather, the examples merely guide the trained model to emulate the behavior of the helpers from the help sessions.

In other cases, generative models can be tuned to specific games or specific game genres by updating internal model parameters. For instance, note that many fighting games involve common features, such as a health bar on the screen reflecting a player's health, “boss” fights against particularly powerful enemies, etc. A pretrained generative model can be tuned on a training data set of multiple games from one genre (e.g., fighting games) and tuned on another training data set of multiple games from another genre (e.g., racing games). Then, the instance of the model tuned on the fighting games can be employed for help sessions involving fighting games, potentially including new fighting games that were not seen during tuning. Similarly, the instance of the model tuned on the racing games can be employed for help sessions involving racing games, potentially including new racing games that were not seen during tuning.

In some cases, help sessions can be offered using human helpers until the trained machine learning model reaches a threshold level of competency, at which point the trained machine learning model can be offered as an alternative to a human helper or replace them entirely. For instance, once a trained machine learning model achieves a threshold (e.g., 90%) success rate at achieving a particular in-game goal, then the trained machine learning model can be employed as a helper. Until that time, additional human helper sessions can be provided to obtain further training data while continuing to train the machine learning model.

In still further implementations, a demonstration mode is offered where a trained machine learning model can conduct a help session, but the results of that help session do not persist. In other words, after the help session, the video game can revert to the prior game state and the current video game player can attempt to complete an in-game goal on their own after viewing the demonstration. Also, note that some implementations may offer the current video game player the option of accepting the resulting video game state after a help session and loading that state into their current video game session, or alternatively rejecting that state and resuming the current video game session from the state saved prior to initiating the help session.

### Technical Effect

The disclosed techniques can enable training of machine learning models for help sessions in an efficient manner. By filtering prior gameplay data to identify help sessions associated with a particular in-game condition, the amount of training data utilized to train a given model can be dramatically reduced. This saves storage, memory, processor, and network resources that would otherwise be utilized for model training. Furthermore, this approach can also improve model accuracy by ensuring that the training data seen by the model during training shows effective examples of help sessions that are associated with a specific in-game goal.

In addition, recall that some implementations can employ help session triggering conditions and help session ending conditions to initiate and end help sessions. This has the effect of limiting the number and duration of automated help sessions to specific in-game conditions where help is appropriate, thus preserving computing resources that would otherwise be employed by the trained machine learning model. In addition, this approach provides for improved human-computer interaction by reducing the extent of human input provided to a computer, e.g., by automatically suggesting help session without explicit input from a user initiating a request for help.

### Device Implementations

As noted above with respect to FIG. 8, system 800 includes several devices, including a console client device 810, a mobile client device 820, and a game server 830. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions. When executed the computer-readable instructions can cause the hardware processors to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 840. Without limitation, network(s) 840 can include one or more local area networks (LANs), wide area networks (WANs), the Internet, and the like.

Various examples are described above. Additional examples are described below. One example includes a computer-implemented method comprising accessing prior gameplay data for a particular video game from prior help sessions by one or more video game helpers, evaluating the prior gameplay data to identify selected prior help sessions related to a particular condition in the particular video game, extracting training data from the prior gameplay data for the selected prior help sessions, based on the training data extracted from the selected prior help sessions, training a machine learning model to assist with playing the particular video game, and outputting the trained machine learning model.

Another example can include any of the above and/or below examples where the machine learning model is a neural network.

Another example can include any of the above and/or below examples where the training comprises imitation learning or reinforcement learning.

Another example can include any of the above and/or below examples where the machine learning model is a pretrained generative model, and the training comprises tuning the pretrained generative model.

Another example can include any of the above and/or below examples where the training data comprises particular inputs provided to the particular video game during the selected prior help sessions.

Another example can include any of the above and/or below examples where the training data comprises particular outputs provided by the particular video game during the selected prior help sessions, and the training involves training the machine learning model to produce the particular inputs in response to the particular outputs.

Another example can include any of the above and/or below examples where the evaluating comprises filtering the prior gameplay data based on one or more filtering criteria.

Another example can include any of the above and/or below examples where the filtering criteria correspond to help sessions relating to a common in-game goal.

Another example can include any of the above and/or below examples where the method further comprises inputting the prior gameplay data to a generative model, and filtering the prior gameplay data based at least on output of the generative model that characterizes the prior gameplay data.

Another example can include any of the above and/or below examples where the prior gameplay data includes one or more of gameplay sequences, communication logs, platform data, or instrumented game data.

Another example can include a computer-implemented method comprising initiating a current help session for a current video game player during a current gaming session of a particular video game, during the current help session obtaining output of the particular video game, providing the output to a trained machine learning model, wherein the trained machine learning model has been adapted to assist with playing the particular video game based at least on selected prior help sessions by one or more video game helpers, receiving generated inputs from the trained machine learning model, and providing the generated inputs to the particular video game, and ending the current help session and returning to the current gaming session.

Another example can include any of the above and/or below examples where the machine learning model comprises a generative machine learning model that has been adapted to play the particular video game by inputting prior gameplay data from the selected prior help sessions to the generative machine learning model.

Another example can include any of the above and/or below examples where the machine learning model has been trained or tuned by updating internal parameters of the machine learning model based on prior gameplay data from the selected prior help sessions.

Another example can include any of the above and/or below examples where the current gaming session is executed on a client device and the help session is executed on a remote server device.

Another example can include any of the above and/or below examples where the method further comprises transferring game state of the client device to the server device to initiate the current help session, and transferring game state of the server device to the client device to end the current help session.

Another example can include any of the above and/or below examples where the method further comprises graphically distinguishing a representation of the current game player during the current help session to convey that the trained machine learning model is playing the particular video game.

Another example can include any of the above and/or below examples where the method further comprises using the trained machine learning model to perform a demonstration of gameplay during the current help session and reverting to a prior state when the current help session ends.

Another example can include any of the above and/or below examples where the trained machine learning model comprises a generative model, the demonstration including a natural language description output by the generative model.

Another example can include any of the above and/or below examples where the demonstration includes a graphical depiction of controller inputs generated by the trained machine learning model during the current help session.

Another example can include a system comprising processing resources, and storage resources storing computer-readable instructions which, when executed by the processing resources, cause the processing resources to initiate a current help session for a current video game player during a current gaming session of a particular video game, during the current help session, obtain output of the particular video game and provide the output to a trained machine learning model, wherein the trained machine learning model has been adapted to assist with playing the particular video game based at least on selected prior help sessions by one or more video game helpers, during the current help session, receive generated inputs from the trained machine learning model and provide the generated inputs to the particular video game, and end the current help session and return to the current gaming session.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
accessing prior gameplay data for a particular video game from prior help sessions by one or more video game helpers;
evaluating the prior gameplay data to identify selected prior help sessions related to a particular condition in the particular video game;
extracting training data from the prior gameplay data for the selected prior help sessions;
based on the training data extracted from the selected prior help sessions, training a machine learning model to assist with playing the particular video game; and
outputting the trained machine learning model.

2. The computer-implemented method of claim 1, wherein the machine learning model is a neural network.

3. The computer-implemented method of claim 2, wherein the training comprises imitation learning or reinforcement learning.

4. The computer-implemented method of claim 2, wherein the machine learning model is a pretrained generative model, and the training comprises tuning the pretrained generative model.

5. The computer-implemented method of claim 1, wherein the training data comprises particular inputs provided to the particular video game during the selected prior help sessions.

6. The computer-implemented method of claim 5, wherein the training data comprises particular outputs provided by the particular video game during the selected prior help sessions, and the training involves training the machine learning model to produce the particular inputs in response to the particular outputs.

7. The computer-implemented method of claim 1, wherein the evaluating comprises filtering the prior gameplay data based on one or more filtering criteria.

8. The computer-implemented method of claim 7, the filtering criteria corresponding to help sessions relating to a common in-game goal.

9. The computer-implemented method of claim 8, further comprising:
inputting the prior gameplay data to a generative model; and
filtering the prior gameplay data based at least on output of the generative model that characterizes the prior gameplay data.

10. The computer-implemented method of claim 1, wherein the prior gameplay data includes one or more of gameplay sequences, communication logs, platform data, or instrumented game data.

11. A computer-implemented method comprising:
initiating a current help session for a current video game player during a current gaming session of a particular video game;
during the current help session:
obtaining output of the particular video game;
providing the output to a trained machine learning model, wherein the trained machine learning model has been adapted to assist with playing the particular video game based at least on selected prior help sessions by one or more video game helpers;
receiving generated inputs from the trained machine learning model; and
providing the generated inputs to the particular video game; and
ending the current help session and returning to the current gaming session.

12. The computer-implemented method of claim 11, wherein the machine learning model comprises a generative machine learning model that has been adapted to play the particular video game by inputting prior gameplay data from the selected prior help sessions to the generative machine learning model.

13. The computer-implemented method of claim 11, wherein the machine learning model has been trained or tuned by updating internal parameters of the machine learning model based on prior gameplay data from the selected prior help sessions.

14. The computer-implemented method of claim 11, wherein the current gaming session is executed on a client device and the help session is executed on a remote server device.

15. The computer-implemented method of claim 14, further comprising:
transferring game state of the client device to the server device to initiate the current help session; and
transferring game state of the server device to the client device to end the current help session.

16. The computer-implemented method of claim 11, further comprising:
graphically distinguishing a representation of the current game player during the current help session to convey that the trained machine learning model is playing the particular video game.

17. The computer-implemented method of claim 11, further comprising:
using the trained machine learning model to perform a demonstration of gameplay during the current help session and reverting to a prior state when the current help session ends.

18. The computer-implemented method of claim 17, the trained machine learning model comprising a generative model, the demonstration including a natural language description output by the generative model.

19. The computer-implemented method of claim 17, the demonstration including a graphical depiction of controller inputs generated by the trained machine learning model during the current help session.

20. A system comprising:
processing resources; and
storage resources storing computer-readable instructions which, when executed by the processing resources, cause the processing resources to:
initiate a current help session for a current video game player during a current gaming session of a particular video game;
during the current help session, obtain output of the particular video game and provide the output to a trained machine learning model, wherein the trained machine learning model has been adapted to assist with playing the particular video game based at least on selected prior help sessions by one or more video game helpers;
during the current help session, receive generated inputs from the trained machine learning model and provide the generated inputs to the particular video game; and
end the current help session and return to the current gaming session.
